(19) United States
(12) Patent Application Publication
(10) Pub. No.: US 2018/0019483 A1
(43) Pub. Date: Jan. 18, 2018

(54) REDOX FLOW BATTERY WITH INCREASED-SURFACE-AREA ELECTRODE AND ASYMMETRIC ELECTROLYTE CONCENTRATION

(71) Applicant: University of Tennessee Research Foundation, Knoxville, TN (US)

(72) Inventors: Alan M. Pezeshki, Knoxville, TN (US); Matthew M. Mench, Knoxville, TN (US); Craig Bridges, Knoxville, TN (US); Michael Cyrus Daugherty, Oak Ridge, TN (US)

(21) Appl. No.: 15/293,187

(22) Filed: Oct. 13, 2016

Related U.S. Application Data
(60) Provisional application No. 62/361,788, filed on Jul. 13, 2016.

(51) Int. Cl. H01M 8/20; H01M 4/88; H01M 4/96; H01M 8/18

(52) U.S. Cl. CPC H01M 8/0482; H01M 8/20; H01M 8/188; H01M 4/8825; H01M 4/96; H01M 8/04276

(57) ABSTRACT

A flow battery having stable electrochemical performance is provided. The flow battery includes a separator disposed between a positive electrode and a negative electrode, a first flow plate to distribute a positive electrolyte to the positive electrode, and a second flow plate to distribute a negative electrolyte to the negative electrode. A material of at least one of the positive and negative electrodes is treated such that a surface area of the material when treated is greater than a surface area of the material when untreated. When the positive and negative electrolytes include vanadium ions, a concentration of vanadium in the positive electrolyte is different from a concentration of vanadium in the negative electrolyte to mitigate crossover-induced capacity fade.

### CROSS-REFERENCE TO RELATED APPLICATIONS

This application claims benefit under 35 U.S.C. §119(e) of U.S. Provisional Application Ser. No. 62/361,788, filed Jul. 13, 2016, which is incorporated herein by reference in its entirety.

### STATEMENT REGARDING FEDERALLY SPONSORED RESEARCH OR DEVELOPMENT

This invention was made with government support under DE-AC05-00OR22725 awarded by the Department of Energy (DOE). The U.S. Government has certain rights in this invention.

### BACKGROUND

The present disclosure generally relates to reduction-oxidation (redox) flow batteries. More specifically, the present disclosure relates to methods and systems for improving the performance, efficiency, and stability of redox flow batteries.

Electrodes and flow of electrolyte species play a determining role in the performance of a flow battery. The power output and efficiency of the flow battery may be affected by degradation of its electrodes and/or an imbalance in the crossover rates of its electrolyte species.

On one hand, flow batteries typically include electrodes that undergo some form of performance degradation over time. For example, most electrode materials undergo significant performance depreciation when used on the negative side of the battery, while the electrode on the positive side generally maintains good stability. Such degradations of negative-side electrodes result in significant decrease in efficiencies and power output capabilities of the batteries. Additionally, energy capacities of these batteries—i.e., the amounts of energy that these batteries can store—are detrimentally reduced.

On the other hand, reduced energy capacity, particularly in vanadium redox flow batteries (VRFBs), is associated with an imbalance in the crossover rates of V²⁺/V³⁺ to the positive side and of VO²⁺/VO₂⁺ to the negative side of the electrode. Crossover occurs as a result of diffusion, electrostatic potential gradients, and convection (both electro-osmotic and hydraulic). The asymmetry in these processes between the negative and positive electrolyte vanadium species leads to crossover-induced capacity fade. If left unmanaged, crossover-induced capacity fade reduces the total amount of energy that can be stored with a fixed amount of vanadium.

Accordingly, methods and systems have been devised to minimize electrode degradation and/or crossover-induced capacity fade.

For example, the average energy efficiency of a vanadium redox flow battery cell has been shown to improve by about 5% by nitrogen-doping graphite felt electrodes to enhance their electrochemical properties, as described in “Effects of nitrogen doping on the electrochemical performance of graphite felts for vanadium redox flow batteries,” by Z. He et al., International Journal of Energy Research, 2015, 39, 709-716. The nitrogen-doped graphite felt electrodes are obtained by heat-treating graphite felt electrodes in an ammonia (NH₃) atmosphere at 600° C. or 900° C., thereby increasing their electrical conductivity, reducing their polarization resistance without changing their surface morphologies, and improving their wettability.

In “Nitrogen-doped mesoporous carbon for energy storage in vanadium redox flow batteries” by Y. Shao et al., Journal of Power Sources, 2010, 195, 4375-4379, mesoporous carbon (MPC) is heat-treated in NH₃ atmosphere at 850° C. for 2 hours to produce nitrogen-doped MPC (N-MPC) to increase the energy storage efficiencies of redox flow batteries with N-MPC electrodes. Although differences, such as specific surface area, pore sizes and distribution, and graphitic structures, between MPC and N-MPC may each contribute to their differences in electrochemical performance, the main difference is claimed to be in the oxygen content and the nitrogen doping, which have been shown to improve the electrocatalytic activity of carbon nanostructures.

In the field of fuel cell, NH₃ gas treatment of a carbon cloth anode has also been shown to increase power output from microbial fuel cells (MFCs). The treatment is proven to increase the surface charge of the anode, as described in “Ammonia treatment of carbon cloth anodes to enhance power generation of microbial fuel cells” by S. Cheng et al., Electrochemistry Communications, 2007, 9, 492-496.

These methods provide a more catalytically active site for electron transfer reaction. In other words, with a nitrogen-doped carbon electrode, the activation energy required for electron to jump from the electrolyte to the carbon and vice versa is reduced. The electrochemical properties of the electrodes are improved, thus improving power outputs and efficiencies. Therefore, improved kinetics via the addition of nitrogen or oxygen-containing surface functionalities is commonly assumed to be the mechanism for performance gains. But it is unclear whether these methods are capable of improving or maintaining the stability of flow batteries in the long run.

Crossover-induced capacity fade is typically mitigated using methods such as electrochemical rebalancing with external electrolysis cells or chemical rebalancing with oxidizing or reducing agents. Another method involves solution remixing, in which some portion or the entire positive and negative electrolytes are mixed and divided into equal volumes to restore equal vanadium concentrations on both sides of the battery.

However, these methods require active control systems to detect and mitigate capacity imbalances. Electrochemical rebalancing and remixing both require energy to restore a balanced state of charge. Further, the external electrolysis cells in electrochemical rebalancing add to the cost of the overall system and chemical rebalancing incurs the cost of consumable chemicals. These active methods are reactionary measures to mitigate capacity fade after it has occurred.

Therefore, in order to maintain system rated power output and capacity of flow batteries, the inventors recognized a need in the art for flow battery systems with electrodes that maintain stable electrochemical performance and/or with systems and methods to passively and proactively prevent or minimize crossover-induced capacity fade.

### BRIEF DESCRIPTION OF THE DRAWINGS

FIG. 1 is a diagram of a flow battery according to an embodiment of the present disclosure.

FIG. 2 shows polarization curves for positive electrodes according to an embodiment of the present disclosure.

FIG. 3 shows current densities for positive electrodes according to an embodiment of the present disclosure.

FIG. 4 shows open circuit impedance spectra for an untreated positive electrode and a treated positive electrode according to an embodiment of the present disclosure.

FIG. 5 shows open circuit ohmic resistances for positive electrodes according to an embodiment of the present disclosure.

FIG. 6 shows open circuit charge transfer resistance for positive electrodes according to an embodiment of the present disclosure.

FIG. 7 shows surface areas for positive electrodes according to an embodiment of the present disclosure.

FIG. 8 shows scanning electrode microscopy images of a treated electrode and an untreated electrode according to an embodiment of the present disclosure.

FIG. 9 shows rate constants for positive electrodes according to an embodiment of the present disclosure.

FIG. 10 shows open circuit finite diffusion resistances positive electrodes according to an embodiment of the present disclosure.

FIG. 11 shows whole-cell pressure drops for positive electrodes according to an embodiment of the present disclosure.

FIG. 12 shows impedance-resolved polarization curves for positive electrodes according to an embodiment of the present disclosure.

FIG. 13 shows polarization curves for negative electrodes according to an embodiment of the present disclosure.

FIG. 14 shows current densities for negative electrodes according to an embodiment of the present disclosure.

FIG. 15 shows open circuit impedance spectra for negative electrodes according to an embodiment of the present disclosure.

FIG. 16 shows open circuit ohmic resistances for negative electrodes according to an embodiment of the present disclosure.

FIG. 17 shows open circuit charge transfer resistance for negative electrodes according to an embodiment of the present disclosure.

FIG. 18 shows surface areas for negative electrodes according to an embodiment of the present disclosure.

FIG. 19 shows rate constants for negative electrodes according to an embodiment of the present disclosure.

FIG. 20 shows open circuit finite diffusion resistances negative electrodes according to an embodiment of the present disclosure.

FIG. 21 shows whole-cell pressure drops for negative electrodes according to an embodiment of the present disclosure.

FIG. 22 shows impedance-resolved polarization curves for negative electrodes according to an embodiment of the present disclosure.

FIG. 23 shows a time evolution of open-circuit impedance spectra for a negative electrode according to an embodiment of the present disclosure.

FIG. 24 shows charge and discharge polarization curves according to an embodiment of the present disclosure.

FIG. 25 shows discharge capacity with symmetric concentrations according to an embodiment of the present disclosure.

FIG. 26 shows discharge capacity with asymmetric concentrations compared to symmetric concentration discharge capacity according to an embodiment of the present disclosure.

FIG. 27 shows coulombic and voltage efficiencies during cycling according to an embodiment of the present disclosure.

### DETAILED DESCRIPTION

An embodiment of the present disclosure provides a flow battery. The flow battery includes a separator disposed between a positive electrode and a negative electrode, a first flow plate to distribute a positive electrolyte to the positive electrode, and a second flow plate to distribute a negative electrolyte to the negative electrode. A material of at least one of the positive and negative electrodes is treated such that a surface area of the material when treated is greater than a surface area of the material when untreated. When the positive and negative electrolytes include vanadium ions, a concentration of vanadium in the positive electrolyte is different from a concentration of vanadium in the negative electrolyte.

Another embodiment of the present disclosure provides a method for preparing a flow battery. The method comprises: providing a negative electrode and a positive electrode; disposing a separator between the negative electrode and the positive electrode; providing a positive electrolyte to be distributed to the positive electrode via a first flow plate; and providing a negative electrolyte to be distributed to the negative electrode via a second flow plate. A material of at least one of the positive and negative electrodes is treated such that a surface area of the material when treated is greater than a surface area of the material when untreated.

Yet another embodiment of the present disclosure provides a flow battery. The flow battery includes a separator disposed between a positive electrode and a negative electrode, a first flow plate to distribute a positive electrolyte including a first group of vanadium ions to the positive electrode, and a second flow plate to distribute a negative electrolyte including a second group of vanadium ions to the negative electrode. At least one of the positive and negative electrodes is made of carbon felt treated in ammonia gas at at least 400° C. for at least one hour. A concentration of vanadium in the first group of vanadium ions is different from a concentration of vanadium in the second group of vanadium ions.

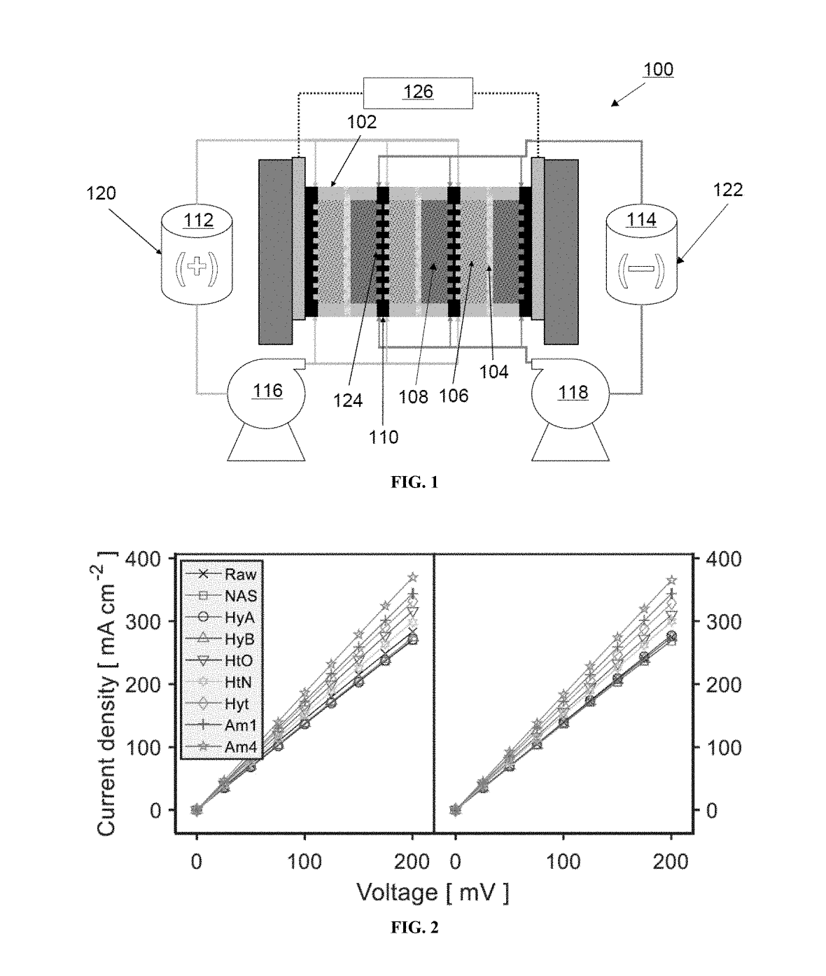

FIG. 1 is a diagram of a flow battery 100 according to an embodiment of the present disclosure. The flow battery 100 may consist of repeated unit cells 102. Each unit cell 102 may consist of two compartments, usually referred to as half-cells, divided by a separator 104. The separator 104 is electronically insulating but ionically conductive. One compartment of a unit cell 102 includes a positive electrode 106 or the other compartment includes a negative electrode 108. Each compartment may include more than one electrode. Both electrodes 106, 108 may be made of porous and conductive materials, and these materials may be carbon-based. As discussed in the Background, the electrodes 106, 108 may be treated to improve the performance of the flow battery 100. The electrodes 106, 108 may be made of either the same material or different materials, and may not necessarily be of the same dimension. Each of the electrodes 106, 108 is compressed between the separator 104 and a conductive flow plate 110, which may be a graphite composite. The flow plate 110 may serve the dual purpose of collecting current and delivering positive and negative electrolytes 112, 114, which are pumped by pumps 116, 118 from reservoirs 120, 122 into the electrodes 106, 108, respectively. Thus, the flow plate 110 is often referred to as a flow field. A channel-land pattern 124 for electrolyte transport is typically etched into the surface of the flow plate 110. In a stack configuration as shown in FIG. 1, the flow plate 110 also contains manifolds to distribute electrolyte through all cells 102 in the stack. In FIG. 1, the flow battery is electrically connected to a source/load 126, which may represent an electric utility grid, for example.

When electrical energy is supplied (electrolytic/charge mode) by the source/load 126 to the flow battery 100, the specie in the positive electrolyte 112 is oxidized at the positive electrode 106 surface, and the electroactive specie in the negative electrolyte 114 is reduced at the negative electrode 108 surface. When electricity is required (galvanostatic/discharge mode) from the flow battery 100 to source/load 126, the reverse reactions occur. Depending on the states of the electrolytes 112, 114, the flow battery 100 may be characterized as either a one-phase or a two-phase flow battery. As a one-phase flow battery, both electrolytes 112, 114 are all liquid (e.g., V/V, V/Fe, V/BrCl, V/Ce, Cr/Fe, Cr/Br, Cr/Cr, S/Br, POxM, Ti/Fe, Ti/BrCl, Np/Np, I/I, Fe(EDTA)/Br, Cr(EDTA), and Quinones/Br). As a two-phase flow battery, the electrolytes 112, 114 may be either hybrid (e.g., Zn/Ni, Zn/Br, Zn/Cl, Zn/BrCl, Zn/V, Zn/Ce, V/O₂, Fe/Fe, Cd/Br, Pb/Pb, Cu/Cu, Cu/Pb, Zn/PANI, Cd/Chloranil, Pb/Tyron, V/Glyoxal(O₂), and V/Cystine(O₂)) or liquid/gaseous (e.g., H/Br, H/Cl, H/Fe, and H/V). Exemplary chemistries for the positive electrolyte 112 include MnO₂/Mn₂O₃, Fe(CN)₆³⁻/Fe(CN)₆⁴⁻, Cu⁺/Cu, Fe³⁺/Fe²⁺, VO₂⁺/VO²⁺, ClBr₂⁻/Br⁻, Br₂/Br⁻, NpO₂⁺/NpO₂²⁺, IO₃⁻/I₂, O₂/O²⁻, HCrO₄⁻/Cr³⁺, Cl₂/Cl⁻, PbO₂/Pb²⁺, Mn³⁺/Mn²⁺, and Ce⁴⁺/Ce³⁺. Exemplary chemistries for the negative electrolyte 114 include Zn(OH)₄²⁻/Zn, Zn²⁺/Zn, Fe²⁺/Fe, S/S₂²⁻, Cr³⁺/Cr²⁺, Cd²⁺/Cd, V³⁺/V²⁺, Pb²⁺/Pb, H⁺/H₂, TiO²⁺/Ti³⁺, Cu²⁺/Cu⁺, Np⁴⁺/Np³⁺, Cu²⁺/Cu, I₂/I⁻.

Hereinafter, methods and systems for improving the performance of a flow battery, such as the flow battery 100, will be described. First, the effects of treating a base electrode material using a plurality of reactants at given temperatures and for given period of times will be described. Second, the effect of using asymmetric electrolyte concentration in a flow battery, particularly a vanadium redox flow battery (VRFB) (i.e., with VO₂⁺/VO²⁺, V³⁺/V²⁺ electrolytes), will be described.

### Electrode Treatment

Typically, the durability/stability of treated electrodes is evaluated by performing a cycling experiment, and an electrode material may be declared “stable” upon observing a stable voltage efficiency. However, electrode degradation may manifest capacity fade, even if the voltage efficiency does not change significantly. Crossover further convolutes cycling experiments. Therefore, the inventors evaluated the effects of a series of treatments on a single baseline electrode material with respect to its initial performance as well as the beginning-of-life performance degradation over the course of a day. Mechanisms underlying observed performance changes both as a result of treatment and as function of time/usage in the battery were investigated.

### Experimental Setup

The investigation employed a vanadium redox flow battery (VRFB) with a 5 cm² active area battery cell with flow plates having a rectangular flow-through flow field design to distribute electrolyte to the electrodes. The separator of the VRFB, a Nafion 117 ion exchange membrane (Ion Power), was first pretreated by immersing in 1 molar (M) H₂SO₄ for 30 minutes at 80° C. and then immersed in deionized water for 30 minutes at 80° C.

The baseline electrode material (Raw) was untreated GFD3 carbon felt (SGL carbon). Eight pretreatments were performed. These treatment conditions are listed in Table I and are referenced hereinafter by the abbreviations listed under the sample name.

TABLE I

| Sample | | | Temp. | Hold | |
|---|---|---|---|---|---|
| name | Treatment type | Reactants | (° C.) | time | |
| Raw | Untreated | | | | |
| HtO | Heat treat | 42% O₂/58% N₂ | 400 | 15 | h |
| HtN | Heat treat | N₂ | 900 | 1 | h |
| Am1 | Heat treat | NH₃ | 900 | 1 | h |
| Am4 | Heat treat | NH₃ | 900 | 4 | h |
| HyB | Hydrothermal | 1:3 HNO₃/H₂SO₄ | 60 | 1 | h |
| HyA | Hydrothermal | 1:3 HNO₃/H₂SO₄ | 80 | 1 | h |
| NAS | Soak | HNO₃ | ambient | 10 | min |

| | | | | |
|---|---|---|---|---|
| Hyt | Hydrothermal + | 1:3 HNO₃ \| | 80 \| 900 | 1 h \| 4 h |
| | heat treat | H₂SO₄ NH₃ | | |

Heat treatments HtO, HtN, Am1, and Am4 were carried out in a tube furnace. The furnace was purged with nitrogen gas at 200 mL/min for one hour prior to heat treatment. Reactant gases were flowed at 200 mL/min during the temperature ramp and treatment. The furnace temperature was ramped from room temperature to the treatment temperature over two hours. The reactant gases, temperatures, and hold times at the treatment temperature are specified in Table I. The oxygen (O₂) treatment was based on known electrode modification. In contrast to the oxidizing environment of the enriched O₂ treatment, ammonia (NH₃) is a reducing agent. The nitrogen (N₂) treatment provided a control for the high temperature of the NH₃ treatment. Although the Am1 and Am4 treatments were carried out at 900° C. for 1 hour and 4 hours, respectively, similar NH₃ treatments may be carried out at lower or higher temperatures and/or for shorter or longer times, and still improve the performance of the flow battery. For example, it may be preferable to treat the base electrode material in NH₃ gas for at least 400° C. and/or for at least 1 hour.

Hydrothermal treatments HyB and HyA were performed in a Teflon-lined autoclave (Columbia International, HTC230-V50) at 60° C. and 80° C. Solutions of 30 mL of concentrated sulfuric acid (H₂SO₄, Alfa Aesar, ACS grade, 96%) and 10 mL of concentrated nitric acid (HNO₃, Alfa Aesar, 70%) were used for both treatments. After the carbon felt was added to the mixed acid solution, the vessel was sealed and immersed in a water bath at the treatment temperature. The reactor vessel internal temperature reached the treatment temperature after 30 min and was held at that temperature for an additional 60 min. Then, the carbon felts were immediately removed and rinsed in deionized water at least five times and stored in deionized water for 8 hours prior to battery testing.

The HNO₃ soak NAS consisted in soaking the carbon felt in a concentrated HNO₃ (Alfa Aesar, 70%) bath for 10 min. The felt was then rinsed in deionized water at least five times and then placed into the battery for testing. The final treatment Hyt combined elements of the hydrothermal and heat treatments. First, the felt was hydrothermally treated at 80° C. in the mixed acid solution described above. After rinsing in deionized water, the felt was dried under vacuum at ambient temperature and placed in the tube furnace. The heat treatment was carried out in the same manner as the Am4 sample.

A stock solution of 0.5 M vanadium/4 M sulfuric acid was prepared by dissolution of VOSO₄ (Alfa Aesar, 99.9%) in a sulfuric acid (Alfa Aesar, ACS grade) solution. The stock solution was filtered after preparation. 50% state-of-charge (SoC) positive (0.25 M VO²⁺/0.25 M VO²⁺) and negative (0.25 M V²⁺/V³⁺) electrolyte solutions were prepared coulometrically by electrolysis of the stock solution in a separate cell.

Measurements were carried out in a symmetric cell configuration; that is, for a given experiment, the same electrolyte solution was circulated through both sides of the cell. A pulse dampener was used to obtain noise-free impedance data. The pressure drop across the cell was measured with a gas-phase pressure transducer (Omega), which was hydraulically connected to the dampener bottle headspace. Because the electrolyte flows through both sides of the cell, the pressure drop reported is for the whole cell. The cell temperature was controlled at 30° C., and a flow rate of 25 mL/min was used.

The cell was operated as a two-electrode cell. Thus, measured cell voltages are across the whole cell. Impedance measurements were taken by holding the DC potential steady for 30 seconds, followed by acquisition of the impedance data with a 5 mV sinusoidal perturbation from 50 kHz to 60 mHz.

After cell assembly, a solution of deaerated 4 M H₂SO₄ was pumped through the cell. Cyclic voltammetry (CV) was performed with a scan rate of 50 mV/s with a voltage window of −0.4 to +0.4 V. Then, electrochemical impedance spectroscopy (EIS) was carried out at −0.2, 0, and +0.2 V DC polarizations.

After CV and EIS measurements with H₂SO₄, the cell was drained and refilled with 50% SoC vanadium solution to evaluate the beginning of life electrochemical performance and durability, in which a total of 20 electrochemical cycles were performed. Each cycle comprised a 30-minute +200 mV imposed cell overpotential followed by a 30-minute −200 mV imposed cell overpotential. This protocol simulates a cycling experiment because alternating the imposed potential on the cell switches the half-cell reaction occurring on each side of the cell between charging and discharging. Open circuit EIS measurements were obtained after every cycle. After every five cycles, a full polarization curve with EIS was taken, obtained in 25 mV increments from 0 to +200 mV.

Over a 25-hour period, the cell was flushed twice with H₂SO₄ solution. Then, the CV and EIS measurements with 4 M H₂SO₄ were performed as described above.

After the completion of cell testing, the electrode materials were removed from the battery, rinsed and stored in deionized water, and then dried under vacuum at ambient temperature. Electron dispersive spectroscopy (EDS), X-ray photoelectron spectroscopy, (XPS) and Raman spectroscopy were used to probe the surface chemistry. An Alpha 300 confocal Raman microscope (WITec, GmbH) was used to collect Raman spectra. A 532 nm excitation laser (spot size 1 μm²) and 20× objective lens were used. Individual spectra acquisition times were 45 seconds. Representative samples were taken as the average of three to four spot spectra from different fibers within the felt. The Raman D:G band ratio was calculated as the ratios of the peak heights after a linear baseline was subtracted. Scanning electron microscopy (SEM) was used to examine the fiber morphology.

### Experimental Results—Positive Electrode

FIG. 2 shows, on the left, polarization curves taken at the beginning and, on the right, polarization curves taken at the end of each experiment for the positive electrodes, as function of the total voltage applied across the cell. At a cell overpotential of 200 mV, the Am4 positive electrode had the highest current density of 370 mA/cm². The NAS positive electrode had the lowest current density of 270 mA/cm². The top five performers were all heat treated in some fashion (Am4, Am1, Hyt, HtO, and HtN), while the remaining four were not. Overall, the positive electrode seems to benefit modestly from treatment.

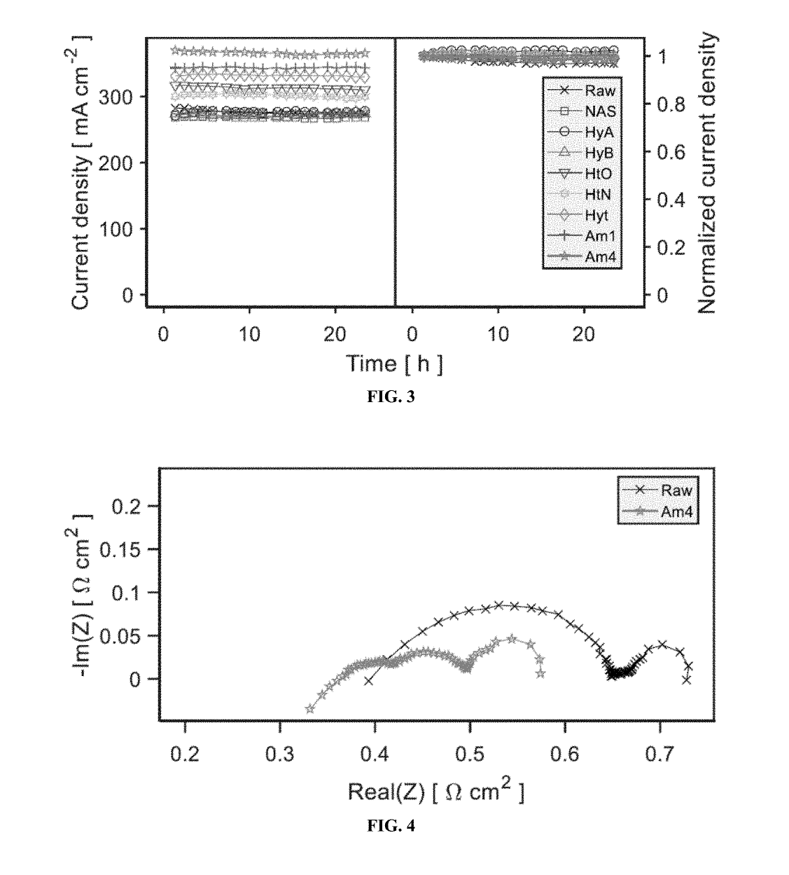

FIG. 3 shows the current densities, at 0.2 V cell overpotential, measured during each potentiostatic step. Based on the normalized currents, the performances of the positive electrodes appear to be stable. The largest decrease in current was the Raw positive electrode with a nearly negligible 5% decline. The largest increase, observed in the Hyt positive electrode, was 4%. Thus, independent of treatment, the positive electrode appears to suffer from very little degradation and in some cases even shows marginal performance improvement.

The open circuit impedance spectra taken at the beginning of the experiment for the Raw positive electrode and the Am4 positive electrode are shown in FIG. 4. The open circuit spectrum for Raw positive electrode is representative of all the other remaining positive electrodes. The magnitudes of the charge transfer feature varied in size for the individual treatments. The charge transfer and ionic resistance features overlapped significantly; the low frequency finite diffusion resistance feature was clearly resolved. For the Am4 positive electrode, the high, middle, and low frequency features attributed to ionic resistance in the pore structure, charge transfer, and finite diffusion, respectively. Hereinafter, the resistances and impedance spectra shown are all at open circuit, i.e., without the passage of current.

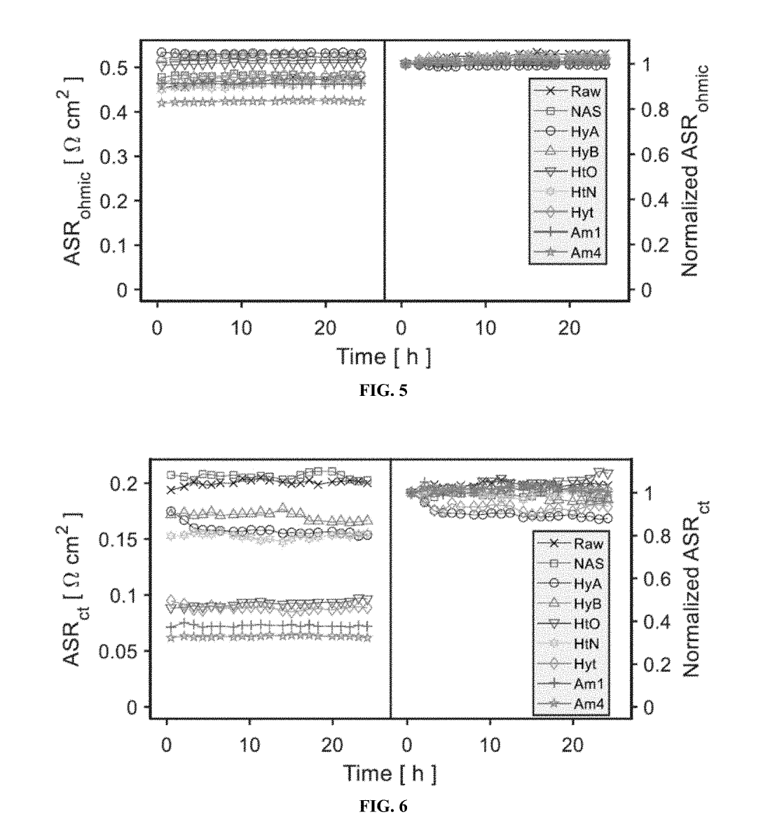

On the positive side of the battery, the total open circuit ohmic resistance, which is the sum of the series (primarily membrane) and distributed ohmic resistances is shown in FIG. 5 for each of the positive electrode. The Am4 positive electrode had the lower total ohmic resistance at 0.42 Ω·cm², and the positive electrodes built with hydrothermally treated felt were the highest at 0.54 Ω·cm². As can be seen from FIG. 5, for the positive electrode, there was no significant change in the ohmic resistance as a function of time.

The charge transfer resistance plays an indirect role in the distributed ohmic resistance; with facile kinetics, the electrode supports high local current densities with minimal charge transfer/activation polarization. Given that the electronic resistivity of the felt material is an order of magnitude lower than that of the electrolyte solution (0.3 vs. 2.48 Ω·cm), the reaction shifts toward the membrane to fine the path of least ohmic resistance. This phenomenon is the origin of the overlap between the charge transfer and distributed ohmic resistances in the impedance spectra.

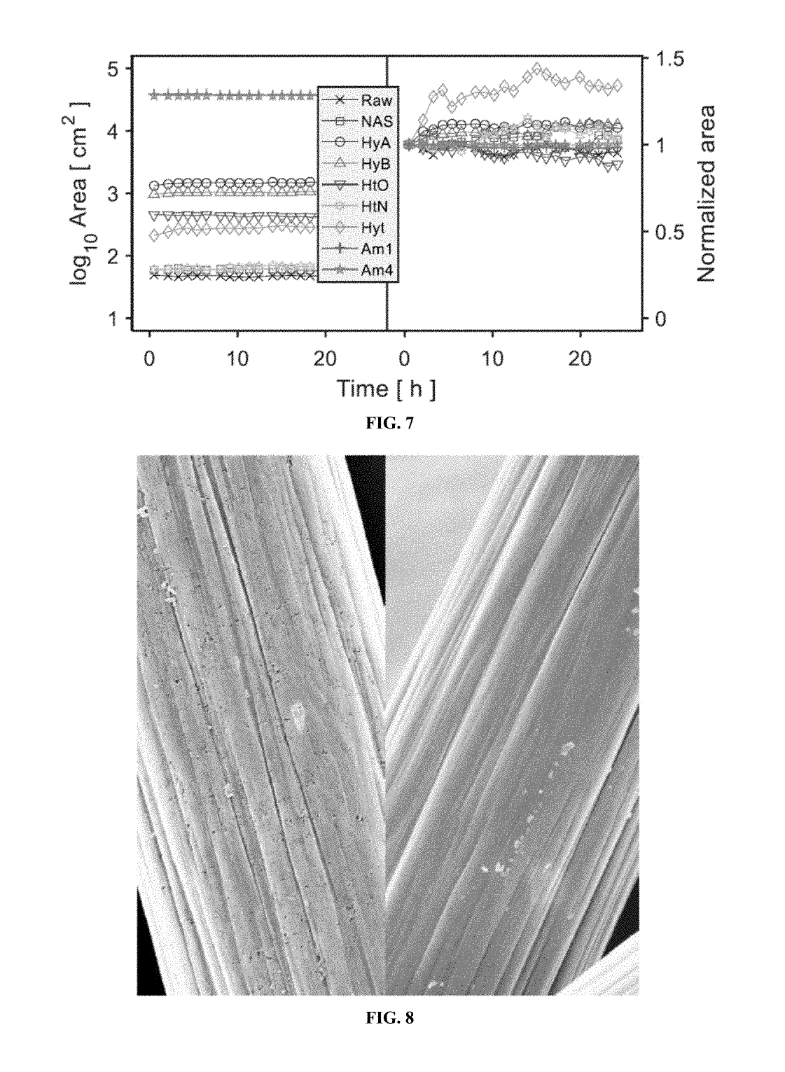

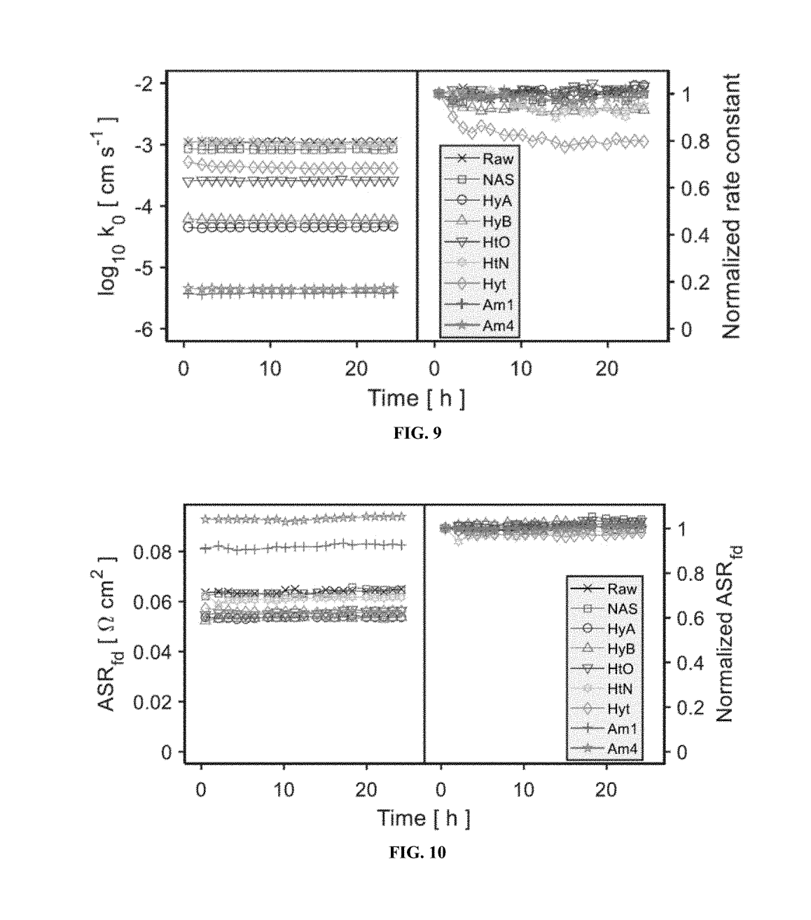

FIG. 6 shows open circuit charge transfer resistances for the positive electrodes. The charge transfer resistances varies from 0.2 Ω·cm² for the Raw and the NAS electrodes to 0.06 Ω·cm² for the ammonia treated electrodes. Thus, treatments can have a strong impact on the charge transfer reaction resistance. The charge transfer resistance as a function of time appears to be stable for all electrode materials, suggesting that the electrode material does not suffer from kinetic deterioration. The charge transfer resistance depends on both the surface area and the inherent activity of the electrode surface, as described below with respect to FIGS. 7 and 9.

The treatments induced significant changes in surface area: the Raw, NAS, and HtN electrodes all had surface areas of about 50 to 60 cm²; the Hyt electrodes had surface areas of 300 cm²; the HtO electrodes had surface areas of 450 cm²; the HyB and HyA electrodes had surface areas of 1000 and 1500 cm², respectively; and the Am1 and Am4 electrodes had surface areas of 37000 cm². The origin of the surface area increase for the mid-range improvements was not resolvable by SEM; however, it is possible that the treatments introduced porosity or roughness that is not visible with SEM but may still be significant. The NH₃ treatment introduced pores with diameters in excess of 30 nm, which were clearly visible in FIG. 8, which shows SEM images of a fiber from one of the NH₃-treated electrodes on the left and a fiber from the Raw electrode on the right. This effect is visible on both positive and negative electrodes.

For each of the positive electrode, the capacitance as a proxy for surface area was measured, assuming a fixed specific double-layer capacitance. Different treatments may result in different specific double-layer capacitances; however, these changes are perhaps a factor of two or three, much smaller than the two orders of magnitude difference observed in surface area. Any error in the surface area calculation due to an incorrect specific double-layer capacitance will propagate to the rate constant calculation, i.e., if the double-layer capacitance is underestimated by 50%, the surface area will be underestimated by 50% and the rate constant overestimated by 50%. FIG. 7 shows surface areas computed from the measured capacitances for each of the positive electrodes.

The rate constant for each positive electrode is shown in FIG. 9. Similar to the electrode area, various treatments induced orders of magnitude differences in the rate constant. Interestingly, the Raw and NAS electrodes, along with the HtN electrode, had the highest rate constant, on the order of 10⁻³ cm/s. The Hyt and HtO electrodes had the next highest relative activity, approximately half an order of magnitude lower than the Raw electrode. Both the HyB and HyA electrodes resulted in a rate constant on the order of 10⁻⁴ cm/s, more an order of magnitude lower than the Raw electrode. The Am1 and Am4 electrodes were yet another order of magnitude lower, approximately 5×10⁻⁵ cm/s. The rate constant appeared to be virtually constant as a function of time independent of treatment, suggesting that the positive electrode is not susceptible to significant degradation.

Given that the exchange current and thus the overall charge transfer resistance is determined by the product of the area and rate constant, neither of these factors is independently enough to judge the effects of electrode treatment on kinetic performance. As described in the Background, numerous studies mentioned have claimed that the mechanism of improved performance for treated carbons used as electrodes in VRFBs is due to a change in surface chemistry. These studies neglected the influence of surface area. The electrode treatment results herein show that any improvement in kinetic performance is solely because the surface area has increased, and further, that the inherent activity of the electrode surface is always lower as a result of chemical or thermal treatment.

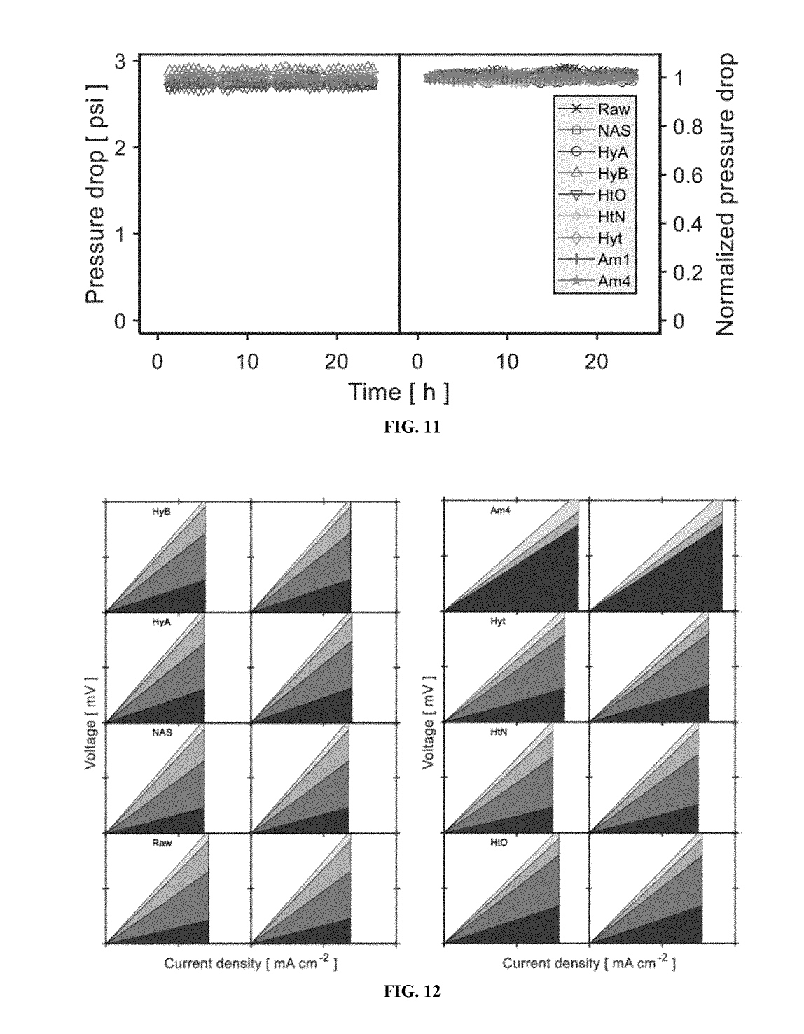

The open circuit finite diffusion resistance for each of the positive electrodes is shown in FIG. 10. All of the non-ammonia heat treated electrodes were tightly packed around a value of 0.06 Ω·cm²; the Am 1 and Am4 electrodes were at around 0.08 to 0.09 Ω·cm², respectively. On average, there was a 1% increase in finite diffusion resistance over the course of a day. The whole-cell pressure drop, measured across both electrodes, was approximately 2.8 psi for all treatments and increased by less than 0.5% on average during the course of each experiment, as shown in FIG. 11. Although these observed changes are not significant, if they are in fact real and continue to increase during operation, performance losses may become appreciable. An increased pressure drop and finite diffusion resistance are likely related, given that the pressure drop and effective diffusion coefficients of the vanadium species in the electrolyte both are positively correlated with tortuosity and electrolyte viscosity, and inversely related to porosity.

The impedance-resolved polarization curves for the positive electrodes are shown in FIG. 12. In FIG. 12, the x-axis scale is set to 400 mA/cm² and the y-axis scale to 200 mV. The first and third columns contain curves obtained at the beginning of the experiment. The second and fourth columns contain curves obtained at the end of the experiment. Colors refer to overpotentials according to the following: dark blue, series ohmic; light blue, distributed ohmic; green, charge transfer; yellow, finite diffusion. Additionally, in FIG. 12, results for the Am1 electrode are not included due to their similarities to the Am4 electrode, and for the Am4 electrode, dark blue represents the sum of series and distributed ohmic resistances. From these curves, it is apparent that the ohmic resistance dominates all losses. In particular, the distributed resistance is a significant contributor. As such, the performance of the positive electrode may be improved by decreasing the ohmic resistance, although the series resistance cannot be changed as a function of electrode because it is primarily due to the membrane. Electrode thickness is another controlling factor; decreasing the electrode thickness may have a larger benefit than any sort of kinetic improvement.

### Experimental Results—Negative Electrode

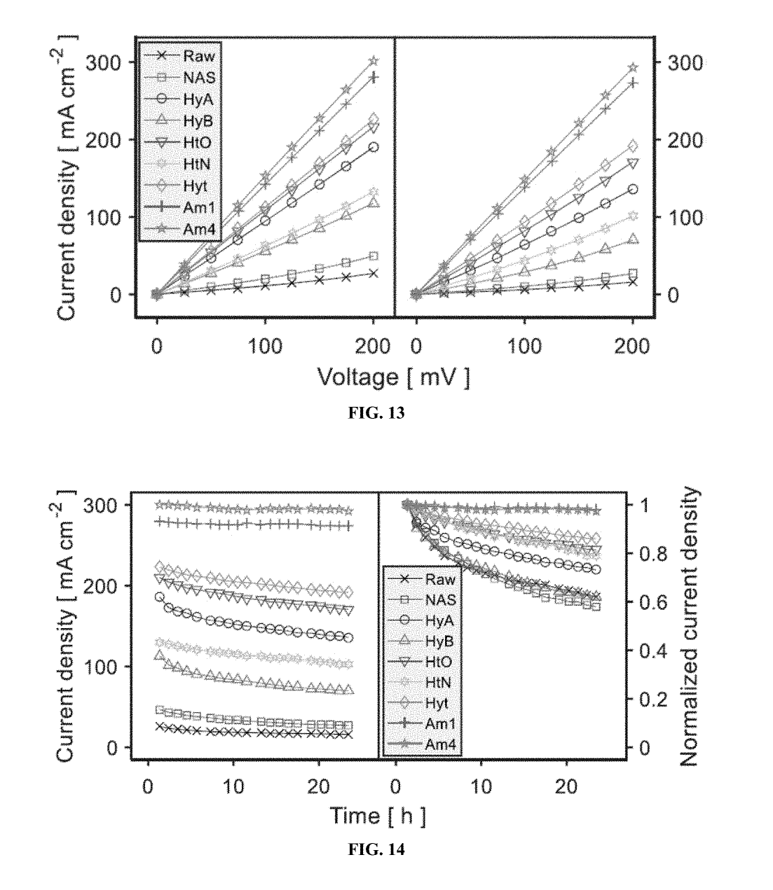

FIG. 13 shows, on the left, polarization curves taken at the beginning and, on the right, polarization curves taken at the end of each experiment for each negative electrode. At a cell overpotential of 200 mV, the Am4 negative electrode had the highest current density of 300 mA/cm² and the Raw negative electrode had the lowest current density of 30 mA/cm², with the remaining electrodes scattered between the two. Overall, it is clear that the performance of the negative electrode is worse than that of the positive electrode, and that the effects of treatments have a much stronger impact on performance on the negative electrode than the positive electrode.

The current densities, at 0.2 V cell overpotential measured during each potentiostatic step is shown in FIG. 14. Unlike the positive electrode, the negative electrode shows appreciable declines in performance. The largest decrease in current was 40% for the Raw, NAS, and HyB negative electrodes. The HyA, HtO, HtN, and Hyt electrodes also showed declines in the neighborhood of 15 to 25%. Only the Am1 and Am4 electrodes were stable, dropping only 2% in current.

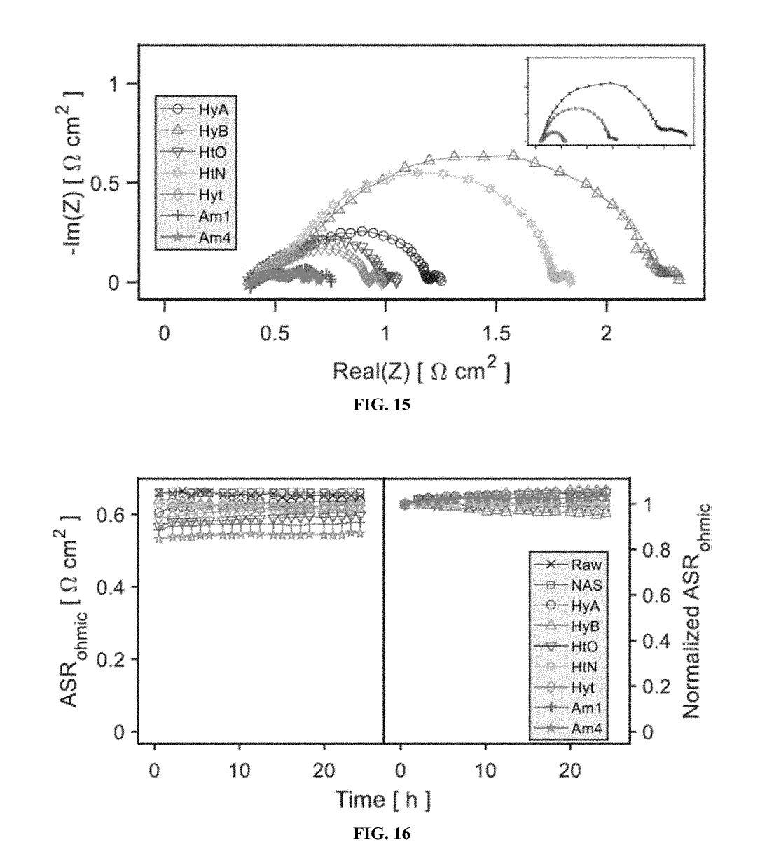

The open circuit impedance spectra for the negative electrodes in FIG. 15 show a wide variation in charge transfer resistances. In FIG. 15, the inset shows the magnitude associated with the Raw electrode (black crosses) and the NAS electrode (red squares) relative to the HyB electrode (pink triangles). The finite diffusion is always clearly resolved; the charge transfer and ionic resistance features are resolved for those treatments with large charge transfer resistances but begin to overlap in the materials with smaller charge transfer resistances. The Am1 and Am4 negative electrodes are very similar in shape to those observed in the positive electrolyte.

Shown in FIG. 16, the ohmic resistance on the negative side ranged between 0.54 and 0.66 Ω·cm², which is 20-25% higher than the 0.48 Ω·cm² average ohmic resistance for the positive side. Half of this difference comes from an increase in the series resistance, attributed nearly entirely to the membrane. The remaining difference is due to a higher distributed ohmic resistance. The resistivity of the negative electrolyte is 5% higher than that of the positive electrolyte. Furthermore, the poor kinetics of the negative side drive a more uniform current distribution over the through the thickness of the electrode. Both of these factors contribute to the higher distributed ohmic resistance.

The charge transfer resistance measured at the beginning of the experiment varied from over 7 Ω·cm² for the Raw electrode to 0.1 Ω·cm² for the Am1 and Am 4 electrodes. This 70× difference is much larger than the factor of three improvement observed on the positive side. The remaining treatments yielded initial charge transfer resistances of 0.3 Ω·cm² (Hyt), 0.4 Ω·cm² (HtO), 0.5 Ω·cm² (HyA), 1.0 Ω·cm² (HtN, HyB), and 5.0 Ω·cm² (NAS). The wide range shows that electrode pretreatments have drastically larger effects on the negative electrode kinetics than on the positive side.

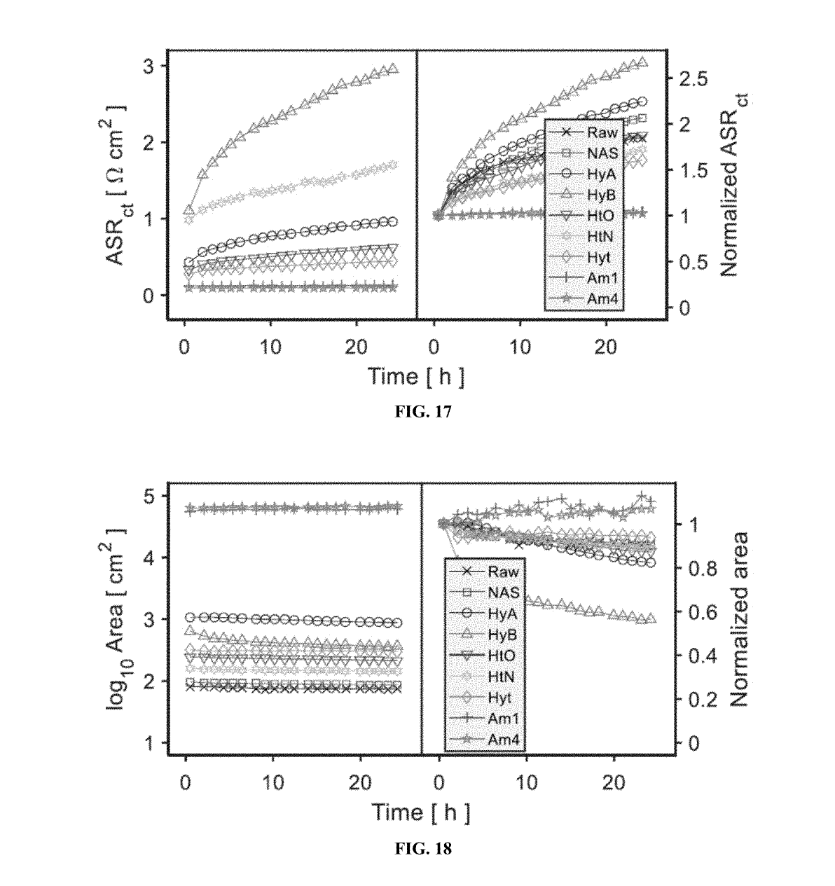

FIG. 17 shows charge transfer resistances for the negative electrodes. In FIG. 17, on the left plot, the charge transfer resistances for the Raw and NAS electrodes are beyond the scale and are therefore not shown. As can be seen, the charge transfer resistances showed an increase of 50-150% for all treatments by the end of the experiment with the exception of that for the Am1 and Am4 electrodes, which remained relatively constant. The degradation in kinetic performance is largest during the first few hours of the experiment. However, by the end of one day, the rate of change remains significant. The effects of such continuous increases in charge transfer resistance are deleterious to battery operation. Given that all treatments tested, except for the ammonia heat treatments, exhibit the continued increase in charge transfer resistance, this is likely to be a common issue with most felt-based electrode materials in the literature. The ammonia heat treated felt is thus an excellent material from the perspective of durability, in addition to its relatively superior performance compared to the other treatments.

The electrode surface areas calculated for the negative side agreed with those on the positive side to within a factor of ±2; such agreement gives confidence that the impedance-resolved areas are reasonably close to the actual values. However, unlike the positive electrodes, the negative side exhibits apparent decreases in surface area of 10-20% for most treatments as shown in FIG. 18, with the Am1 and Am4 electrodes being the notable stable exception. This apparent decrease in surface area is attributed to a change in the total capacitance of the electrode. The EIS measurements taken in sulfuric acid after testing was completed confirm the loss in capacitance. In reality, the loss of capacitance can be due to either a real change in electrochemically active surface area or due to a change in the specific double-layer capacitance as a result of changes on the electrode surface, or a combination of the two. Since the capacitance did not change on the positive side, it is reasonable to assume that the specific capacitance had not changed. The assumption is repeated here, i.e., the change is attributed to an actual loss of surface area rather than a change in specific capacitance. Nonetheless, it may be possible that the specific capacitance changes on the negative electrode while it remains constant on the positive electrode.

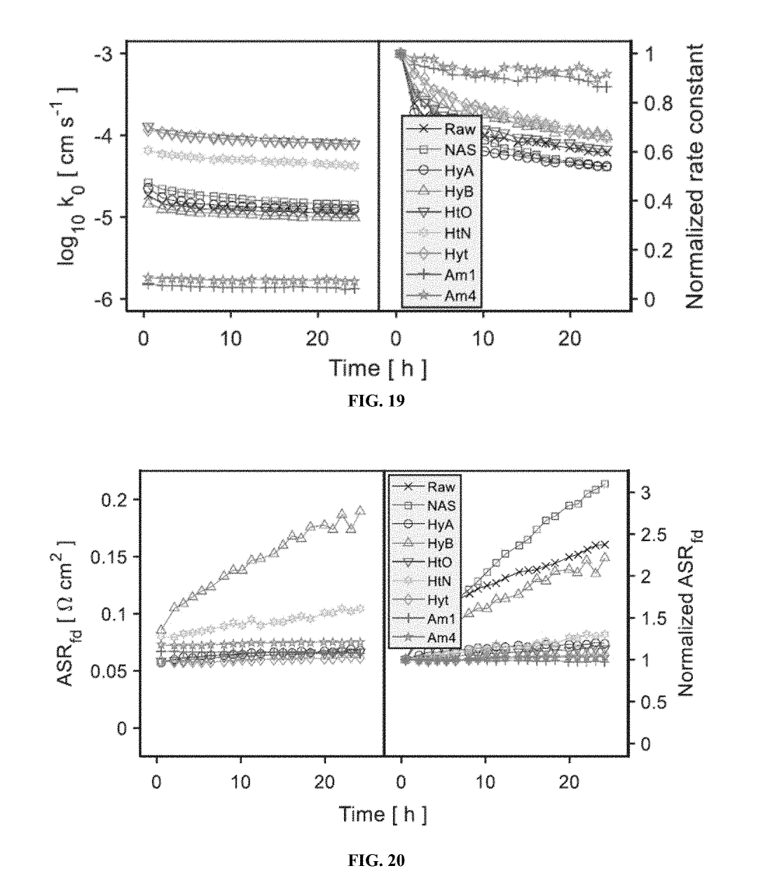

The rate constant for each negative electrode is shown in FIG. 19. For the first portion of the rate constant discussion below, all values discussed are the beginning-of-experiment measured value. The rate constant on the negative side was a factor of 60 lower than the corresponding rate constant measured on the positive side for the Raw material, a factor of 30 lower for the NAS, and a factor of 20 lower for the HtN. The remaining six treatments also all had lower rate constants on the negative side than the positive side, but within factors of two to five. The rate constant shows the most improvement as a result of HtO treatment, increasing by a factor of seven. The Hyt treatment was a factor of six improvement over the Raw, the HtN treatment a factor of three, and the HyA, HyB, and NAS within 40%. The Am1 and Am4 treatments decimated the rate constant (a ten-fold decrease).

In contrast with the positive side, the negative side exhibits a noticeable and significant loss of activity, between 35 and 50% for all treatments other than the Am 1 and Am4 treatments, which had a relatively minor 10% decrease. These changes are best observed in the normalized rate constant portion in FIG. 19. The 35-50% decrease in activity is greater than the 10-20% decrease in surface area, suggesting that the surface activity change is the larger driving force for the decrease in charge transfer resistance than the surface area change.

It is again noted that the rate constant calculation is based on the capacitance-derived surface area. If a drop in the specific double-layer capacitance was the true cause of the decreased total capacitance, the calculated area would be higher. The end result would be an overestimation of the measured rate constant, and so the loss of activity shown in FIG. 19 would be exacerbated. In any case, the loss of activity is both real and significant. The majority of the loss in activity occurs during the first few hours of each experiment, but continues to decline throughout the course of the experiment.

Though the apparent rate constant decreased by up to 10% with the Am1 and Am4 electrodes, the charge transfer resistance increased by only 1-2%. The apparent increase in surface area balanced the loss of activity. While it may be possible that the surface area and rate constant changed in opposite directions at the same rate, the more likely scenario is that neither is changing much and the measured values shifting are an artifact of the equivalent circuit fit. In any case, the activity of the Am1 and Am4 felts is much more stable than that of the other treatments.

The open circuit finite diffusion resistances for all treatments are shown in FIG. 20. In FIG. 20, on the left plot, the charge transfer resistances for the Raw and NAS electrodes are beyond the scale and are therefore not shown. Most were in the range of 0.05 to 0.08 Ω·cm². The noticeable exceptions were the Raw (1.65 Ω·cm²) and the NAS (0.45 Ω·cm²). The Raw, NAS, and HyB all showed large increases by the end of the experiment. The finite diffusion resistance more than doubled in each of the three cases. The remaining six treatments varied from no change (Am1 and Am4) up to a 30% increase (HtN). Given that the positive side showed minimal change in finite diffusion resistance, the mechanism for increased diffusion resistance is unlikely to be related to purely mechanical degradation in the electrode structure. De-wetting of the electrode, which decreases the surface area and increases the local current density, is a potential culprit.

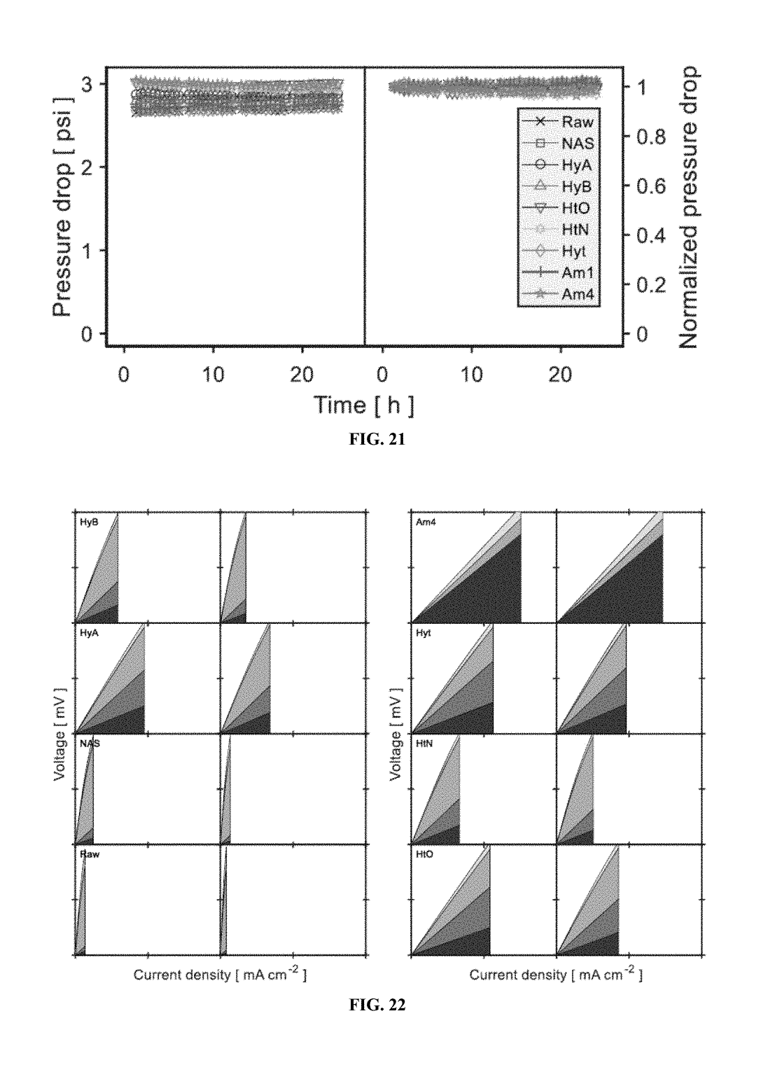

The whole-cell pressure drop, measured across both electrodes, was approximately 2.9 psi for all treatments and showed virtually no change during operation, as shown in FIG. 21. The impedance-resolved polarization curves for the negative side are shown in FIG. 22. In FIG. 22, the x-axis scale is set to 400 mA/cm² and the y-axis scale to 200 mV. The first and third columns contain curves obtained at the beginning of the experiment. The second and fourth columns contain curves obtained at the end of the experiment. Colors refer to overpotentials according to the following: dark blue, series ohmic; light blue, distributed ohmic; green, charge transfer; yellow, finite diffusion. Additionally, in FIG. 22, results for the Am1 electrode are not included due to their similarities to the Am4 electrode, and for the Am4 electrode, dark blue represents the sum of series and distributed ohmic resistances. The relatively high performance electrodes (Am1, Am4, HtO, Hyt, and HyA) indicate ohmic limitation, again with a large distributed resistance contribution. The poor-performance electrodes are kinetically limited. The decrease in kinetic performance gradually increases the share of kinetic overpotential as a fraction of the total.

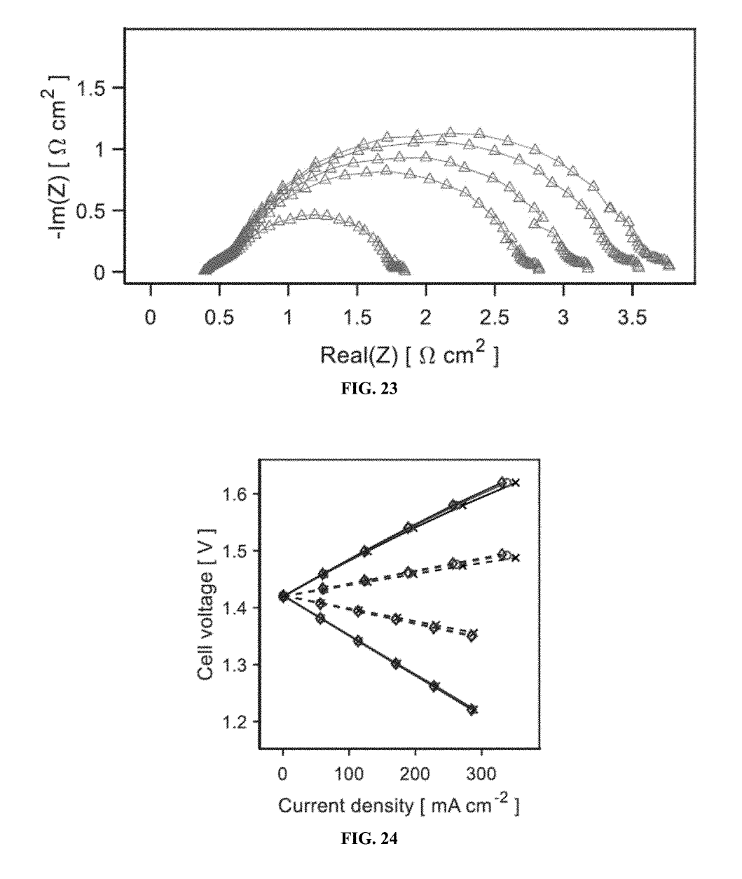

FIG. 23 shows the time evolution of the open-circuit impedance spectra for the HyB electrode, evenly spaced by five-hour increments. The open circuit impedance spectra show the increasing charge transfer resistance.

### Experimental Results—Physicochemical Characterization

The results of the XPS and EDS analyses yielded a total oxygen content of 3-6% (elemental composition) for all electrodes. The impact of usage in the battery was minimal, with post-mortem samples falling within a similar range. Measurable quantities of nitrogen were not present in any sample. The type of functionality was essentially the same in all electrodes, independent of treatment and electrode polarity. Thus, it appears that, at least for the GFD3 carbon material, oxygen functional groups play little to no role in affecting the redox kinetics of either half-cell reaction.

The Raman results are shown in Table II. The D:G band ratio and G band position both point to the graphitic character of the carbon. The location of the G band for the Raw material suggests that it is primarily nanocrystalline graphite. The HyA, HyB, and NAS treatments had similar properties. The heat treatments resulted in lower D:G ratios and a G band shift toward lower wavenumbers. Coupled with the sharper peak shapes (smaller widths), the samples may be more ordered, i.e., they are composed of larger graphite crystals. There appears to be little correlation between the Raman results and the rate constants for both the positive and negative electrodes. Furthermore, there was little change in the Raman data post-mortem.

TABLE II

| | I_{D}/I_{G} | G position (cm⁻¹) | D band width | G band width |
|---|---|---|---|---|
| Raw | 1.33 | 1595.6 | 32.0 | 32.0 |
| NAS | 1.38 | 1597.6 | 36.7 | 33.9 |
| HyA | 1.40 | 1595.9 | 32.0 | 32.0 |
| HyB | 1.39 | 1595.1 | 28.9 | 30.6 |
| HtO | 1.28 | 1594.3 | 27.6 | 29.3 |
| HtN | 1.25 | 1592.6 | 26.2 | 28.7 |
| Hyt | 1.12 | 1591.9 | 24.2 | 27.1 |
| Am1 | 1.02 | 1591.8 | 26.1 | 28.5 |
| Am4 | 1.21 | 1593.1 | 26.0 | 27.9 |

Overall, there appeared to be little correlation between surface functional groups as measured by XPS/EDS and the rate constant. Similarly, Raman results also had little correlation with the rate constant, implying that the graphitic phase of the material did not play a large role in controlling surface activity. It must be noted that Raman spectroscopy penetrates into the bulk of the material and is not surface-sensitive. Therefore, the Raman results herein are not a sufficient negative result to show that the graphitic phase of the material is unimportant. In other words, other techniques sensitive to the surface properties of carbon such as near-edge X-ray absorption spectroscopy (NEXAFS) may be useful. With both XPS/EDS and Raman results, there did not appear to be significant changes in the surface as a function of usage in the battery. Coupled with the fact that the rate constant measured in the negative electrode did change with usage, these results show that these methods alone cannot explain why the negative electrode activity changes.

### Asymmetric Electrolyte Concentration

As discussed in the Background, in VRFBs, an imbalance in the crossover rates of V²⁺/V³⁺ to the positive side and of VO²⁺/VO₂⁺ to the negative side of the electrode leads to crossover-induced capacity fade. Conventional methods employed to mitigate this crossover-induced capacity fade require active control systems, which generally add to the costs of the overall system.

Here, an alternative method is presented in which asymmetric concentrations are used to alter the net crossover rate and reduce crossover-induced capacity fade. Using decreased vanadium concentration on the negative side, the steady-state capacity retention is greatly improved relative to using equal concentrations on either side of the battery. The strategy employed herein is specific to the cell design (i.e., membrane, flow fields, and electrodes), cycling profile (i.e., constant current cycling at a 300 mA/cm²), and operating conditions (i.e., temperature and flow rate). In a true electric grid-connected energy storage application, the cycling profile is more complex, with variable charge/discharge currents. A power utility seeking to minimize crossover-induced capacity fade could apply computational modeling to select the optimal concentration asymmetry. The computational model must account for all modes of crossover and would use the expected average load profile seen by the power utility as an input.

### Experimental Setup

A single 5 cm² active area battery cell with a Nafion 212 ion exchange membrane and flow plates having rectangular flow-through flow fields to distribute electrolytes to carbon felt (SGL GFD3) electrodes was tested. The felt electrodes were heat treated for 4 hours at 900° C. in flowing gaseous NH₃ as described above. The cell temperature was controlled at 30° C., and a flow rate of 50 mL/min was provided by a dual-channel peristaltic pump. Electrolyte solutions with varying vanadium concentrations were prepared by dissolving VOSO₄ in sulfuric acid, followed by filtration to remove impurities. A separate cell was used to charge the initial solutions to V²⁺ and VO²⁺, after which one half of the positive electrolyte was removed to have equal amounts of total vanadium in either side. The cycling experiments were carried out at 300 mA/cm². The charge and discharge voltage cutoffs were 1.7 V and 0.6 V, respectively. Polarization curves were taken periodically with a solution comprised of 1.5 M vanadium/4.5 M total sulfate concentration coulometrically tuned to 50% SoC. During the polarization curve experiments, EIS was performed to measure the high-frequency intercept of the Nyquist plot (HFR) as a proxy for the ohmic resistance of the cell. The HFR captures the entirety of the membrane resistance and a portion of the distributed resistance through the thickness of the electrode.

The first set of cycling experiments used equal 1.5 M vanadium concentrations on either side of the battery (i.e., symmetric concentration) to establish a baseline for capacity fade. Periodic remixing was carried out to deconvolute crossover- and degradation-induced capacity fade. Polarization curves were taken with 50% SoC solutions to measure the cell performance degradation independent of solution.

To demonstrate the impact of concentration asymmetry on capacity fade, the second set of cycling experiments began with 1.5 M vanadium on the positive side and 0.9 M vanadium on the negative side (i.e., asymmetric concentration). After a steady state capacity was reached, 3 M sulfuric acid was added to the negative side to further alter the concentration asymmetry relative to the initial 1.5 and 0.9 M concentrations.

### Experimental Results—Symmetric Concentration

The first cycling experiment was performed with 50 mL of 1.5 M vanadium solution on either side of the battery. Prior to cycling, a set of charge and discharge polarization curves was taken to measure the cell performance under reproducible conditions. The first cycle capacity was 1.65 Ah, declining to 0.95 Ah after one week of cycling (93 cycles). The electrolyte was reconditioned by mixing the positive and negative solutions and then dividing the mixed solution into two equal volumes, thereby restoring the initial 1.5 M vanadium concentrations. The solutions were then tuned coulometrically to 50% SoC for a second set of polarization curves.

FIG. 24 shows uncorrected (solid lines) and HFR-corrected (dashed lines) charge and discharge polarization curves obtained with coulometrically tuned 50% SoC electrolyte. uncorrected voltage. In FIG. 24, the black crosses represent curves obtained before any cycling; the red circles curves obtained after 1 week, 93 cycles; the blue diamonds curves obtained after 3 weeks, 343 cycles. As can be seen in FIG. 24, the HFR-corrected charge and discharge polarization curves shows a slight increase in overpotential from the pristine to the 1-week cycled cell, suggesting some electrode degradation/deactivation had occurred. At a current density of 200 mA/cm², the increase in HFR-corrected overpotential was 4 mV. After the polarization curves were taken, cycling was resumed with the reconditioned electrolyte. The discharge capacity of the first cycle post-reconditioning was 1.54 Ah, or 94% of the first cycle with fresh electrolyte. The 6% difference is attributed to the increase in cell overpotential as measured with the polarization curve.

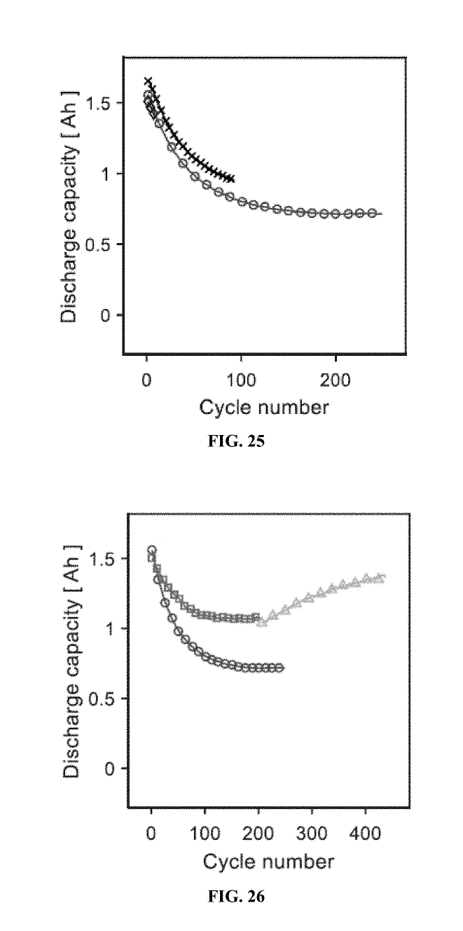

The cell was cycled for an additional two weeks (249 cycles, or cycles 94-343). At the end of these two weeks, a stable capacity of 0.72 Ah was reached, as shown in FIG. 25. In FIG. 25, the black crosses represent discharge capacity during the first week of cycling (93 cycles) and the red circles discharge capacity for the 249 cycles after remixing at the end of the first 93 cycles (cycles 94-343). This portion of cycling lasted two weeks, after which the third set of polarization curves was taken (blue diamonds in FIG. 24). The blue diamonds thus represent discharge capacity for the nine cycles after the second remixing. The steady capacity indicates that the driving forces for crossover had equilibrated and that the vanadium concentrations in either half-cell were at a steady state. The vanadium concentration in the positive half-cell cycling solution was estimated by discharging to 0% SoC and recharging to 100% SoC with a separate excess negative electrolyte solution. Similarly, the negative half-cell cycling solution vanadium concentration was estimated by discharging to 0% SoC and recharging to 100% SoC with a separate excess positive electrolyte solution. The steady-state positive and negative solution concentrations were about 1.9 M and about 1.1 M total vanadium, respectively.

The solution was then reconditioned with remixing to restore the 1.5 M vanadium concentrations in both sides and tuned to 50% SoC as described above. The charge and discharge polarization curves measured at 50% SoC showed a 2 mV increase in HFR-corrected cell overpotential at 200 mA/cm² from the end of week one polarization curves to the end of week three. The 2 mV increase over weeks two to three compared to the 4 mV increase over week one suggests that the rate of electrode degradation decelerated. Cycling was again resumed for one day (nine cycles) with the reconditioned electrolyte. The discharge capacity immediately after this second remixing was 1.51 Ah, i.e., 98% of the capacity after the first electrolyte reconditioning step. Thus, additional electrode degradation during cycles 94-343 contributed only 2% to capacity fade, while the remaining 51% was from crossover. The rate of capacity fade after initial cell build as well as the subsequent capacity fade after the first and second electrolyte reconditioning steps was reproducible.

### Experimental Results—Asymmetric Concentration

The electrolyte solutions were then removed from the cell and replaced with fresh 50 mL of 1.5 M total vanadium on the positive side and 83.3 mL of 0.9 M total vanadium on the negative side. The volumes were chosen to ensure that the total molar quantity of vanadium was equal on both sides. The cell was not rebuilt between symmetric and asymmetric experiments, so any electrode degradation is cumulative. The cycle 1 capacity during asymmetric cycling was 1.50 Ah.

FIG. 26 shows the asymmetric concentration discharge compared to the symmetric case. The red circles represent cycles 94-343 of the symmetric cycling, the magenta squares discharge capacity for the first two weeks of asymmetric concentration cycling (204 cycles), and the cyan triangles discharge capacity during cycling after 3 M sulfuric acid was added to the negative side. Similar to the symmetric concentration experiments described above, the capacity declined. However, the steady-state value of 1.07 Ah (obtained after about 2 weeks and 204 cycles) was significantly higher than the 0.72 Ah in the symmetric concentration case. The fact that capacity fade still occurred means that the 1.5 M positive/0.9 M negative initial vanadium concentration still has a net driving force for vanadium crossover from one side to the other. The observed half-cell potentials suggest that the net transport of vanadium was still from the negative to positive side. However, the lower rate of capacity fade and higher steady-state capacity confirm that lowering the vanadium concentration on the negative side relative to the positive can partially mitigate capacity fade. In principle, with knowledge of all crossover mechanisms, one could predict the concentration asymmetry that would completely mitigate capacity fade. Again, the charge/discharge profiles and other operating conditions will influence the driving forces for net crossover and thus alter the optimal concentration asymmetry.

### Experimental Results—Secondary Dilution

After the asymmetric concentration cycling experiment reached a stable capacity, 17 mL of deaerated 3 M sulfuric acid was added to the negative electrolyte. The steady-state result achieved with this second dilution corresponds to an asymmetric concentration cycling experiment with 50 mL of 1.5 M vanadium on the positive side and 100 mL of 0.75 M vanadium on the negative side. The additional dilution of the negative side was expected to draw vanadium back to the negative side. The first cycle immediately after the second dilution step had an expected small drop in capacity. When the vanadium concentration is decreased, the charge transfer and mass transport overpotentials increase, which means the charge voltage reaches the cut-off voltage at a lower SoC. However, 234 cycles after the second dilution, the capacity recovered to over 1.38 Ah or 92% higher than the 0.72 Ah steady state capacity obtained with the symmetric concentration experiment.

### Experimental Results—Cycling Efficiencies

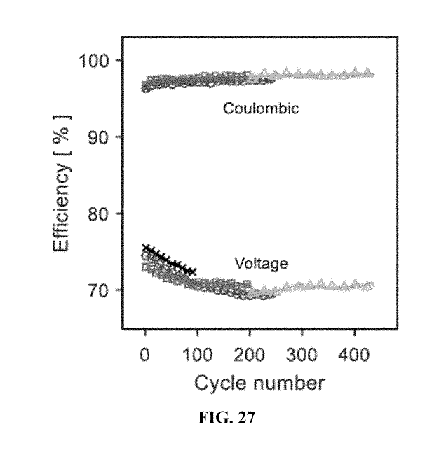

FIG. 27 shows the coulombic and voltage efficiencies during cycling. In FIG. 27, the black crosses represent symmetric concentration cycles 1-93, the red circles symmetric concentration cycles 94-343, the magenta squares asymmetric concentration cycles 1-204, and the cyan triangles asymmetric concentration after the secondary dilution. The coulombic efficiency (CE) was relatively constant over the course of cycling. During the symmetric concentration case, the first cycle CE was 96.3%, rising to 97.3% after about 120 cycles. The first cycle CE was again 96.3% after the electrolyte reconditioning, and after about 120 cycles again reached 97.3%, where it remained stable until the experiment was ended. During the asymmetric concentration case, the CE began at 96.7% and reached 97.3% within 10 cycles. After the capacity stabilized, the CE had also stabilized at 97.9%. After the second dilution step, the CE slightly increased to 98.1%, where it remained stable. Thus, the concentration asymmetry had a marginally beneficial effect on the CE.

The voltage efficiency (VE) during the symmetric concentration case was 75.5% during cycle 1, dropping to 72.2% for cycle 93. Some portion of this drop was due to the electrode degradation increasing the cell overpotential, measured with the polarization curves. The remaining drop in VE can be attributed to crossover. The charge transfer and finite diffusion overpotentials are inversely related to vanadium concentration. As the vanadium is depleted on the negative side as a result of crossover, the charge transfer and finite diffusion overpotentials in the negative half-cell increase. After reconditioning the electrolyte, the symmetric concentration VE recovered to 74.4%. Thus, about 1% of the drop in VE can be attributed to electrode degradation, and the remaining 2% can be attributed to crossover-induced concentration changes on the negative side. As crossover progressed during cycles 94-343 of the symmetric concentration case, the VE dropped from 74.4% to stabilize around 69.2%.

The VE for cycle 1 during the asymmetric concentration case was 73.0%. This is lower than the VE during cycle 1 for the symmetric concentration case because the lower concentration on the negative half-cell increases the overpotential. Over 204 cycles, the VE dropped to 70.6%, again due to additional depletion of vanadium in the negative half-cell. When the second dilution step was performed, the VE further decreased to 69.5%. However, as vanadium returned to the negative side, the VE increased back to 70.7%. Overall, the asymmetric concentration appears to have an initially detrimental effect on VE. However, if both cases are allowed to reach steady state capacity, the asymmetric concentration has a marginally higher VE than the symmetric concentration case.

Several embodiments of the disclosure are specifically illustrated and/or described herein. However, it will be appreciated that modifications and variations of the disclosure are covered by the above teachings and within the purview of the appended claims without departing from the spirit and intended scope of the disclosure. Further variations are permissible that are consistent with the principles described above.

1-20. (canceled)

21. A flow battery, comprising:
a separator disposed between a positive electrode and a negative electrode;
at least one flowing electrolyte; and
at least one flow plate to distribute the at least one flowing electrolyte,
wherein a material of at least one of the electrodes is treated such that a surface area of the material when treated is at least 50 times greater than a surface area of the material when untreated.

22. The flow battery of claim 21, wherein the at least one flowing electrolyte comprises:
a positive electrolyte that includes a first group of vanadium ions, and
a negative electrolyte that includes a second group of vanadium ions;
wherein the at least one flow plate comprises:
a first flow plate to distribute the positive electrolyte to the positive electrode, and
a second flow plate to distribute the negative electrolyte to the negative electrode; and
wherein a concentration of vanadium in the first group is different from a concentration of vanadium in the second group.

23. The flow battery of claim 22, wherein the concentration of vanadium in the first group is greater than the concentration of vanadium in the second group.

24. The flow battery of claim 22, wherein the concentration of vanadium in the first group is 1.5 molar and the concentration of vanadium in the second group is 0.9 molar.

25. The flow battery of claim 21, wherein the material is carbon felt.

26. The flow battery of claim 25, wherein the material is treated in a gas at a temperature of at least 400° C. for at least one hour.

27. The flow battery of claim 26, wherein at least one of the electrodes is treated in ammonia gas.

28. The flow battery of claim 25, wherein the material is treated in gas at a temperature of at 900° C. for four hours.

29. The flow battery of claim 28, wherein at least one of the electrodes is treated in ammonia gas.

30. The flow battery of claim 21, wherein the surface area of the material when treated is at least 700 times the surface area of the material when untreated.

31. The flow battery of claim 21, wherein the at least one flow plate includes a flow plate having flow-through flow fields.

32. The flow battery of claim 21, wherein treating the material introduces pores into the material.

33. The flow battery of claim 32, wherein the pores have a diameter in excess of 30 nm.

34. The battery of claim 21, wherein the at least one flowing electrolyte includes an electrolyte comprising vanadium ions.

35. The battery of claim 21, wherein the at least one flowing electrolyte includes an electrolyte comprising bromine ions.

36. The battery of claim 21, wherein the at least one flowing electrolyte includes an electrolyte comprising chlorine ions.

37. The battery of claim 21, wherein the at least one flowing electrolyte includes an electrolyte comprising iron ions.

38. The battery of claim 21, wherein the at least one flowing electrolyte includes an electrolyte comprising polysulfide ions.

39. The battery of claim 21, wherein the at least one flowing electrolyte includes an electrolyte comprising zinc ions.

40. The battery of claim 21, wherein the at least one flowing electrolyte includes an electrolyte comprising chromium ions.

41. The battery of claim 21, wherein the at least one flowing electrolyte includes an electrolyte comprising sodium ions.

42. The battery of claim 21, wherein the material is carbon paper.

43. The battery of claim 21, wherein the material comprises carbon fibers and carbon particles.

44. A method for preparing a flow battery, comprising:
providing a negative electrode and a positive electrode;
disposing a separator between the negative electrode and the positive electrode;
providing at least one electrolyte to be distributed to the electrode via a flow plate,
wherein a material of at least one of the electrodes is treated such that a surface area of the material when treated is at least 50 times greater than a surface area of the material when untreated.

45. The method of claim 44, wherein the at least one electrolyte comprises a positive electrolyte and a negative electrolyte.

46. The method of claim 45, further comprising, prior to providing the positive and negative electrolytes, preparing the positive and negative electrolytes such that a concentration of vanadium in the positive electrolyte is different from a concentration of vanadium in the negative electrolyte.

47. The method of claim 46, wherein the positive and negative electrolytes are prepared such that the concentration of vanadium in the positive electrolyte is greater than the concentration of vanadium in the negative electrolyte.

48. The method of claim 47, wherein the positive and negative electrolytes are prepared such that the concentration of vanadium in the positive electrolyte is 1.5 molar and the concentration of vanadium in the negative electrolyte is 0.9 molar.

49. The method of claim 47, wherein the material is carbon felt.

50. The method of claim 49, further comprising, heat treating the material in gas at a minimum temperature of 400° C. for at least one hour.

51. The method of claim 50, where at least one of the electrodes is treated in ammonia gas.

52. The method of claim 51, wherein the heat treating of the material increases the surface area of the material by at least 700 times.

53. The method of claim 52, further comprising, prior to the providing the negative electrode and the positive electrode, heat treating the material of at least one of the positive and negative electrodes in a gas at 900° C. for four hours.

54. The method of claim 53, wherein at least one of the electrodes is treated in ammonia gas.

55. The method of claim 54, wherein the heat treating the material increases the surface area of the material by at least 700 times.

56. The method of claim 54, wherein at least one of the first and second flow plates includes flow-through flow fields.

57. The method of claim 54, wherein treating the material introduces pores into the material.

58. The method of claim 54, wherein the pores have a diameter in excess of 30 nm.

59. The method of claim 44, wherein the material is carbon paper.

60. The method of claim 44, wherein the material comprises carbon fibers and carbon particles.

61. The method of claim 44, wherein at least one of the electrodes is carbon felt.

62. A flow battery, comprising:
a separator disposed between a positive electrode and a negative electrode;
a first flowing electrolyte including a first group of ions;
a second flowing electrolyte including a second group of ions;
a first flow plate to distribute the first flowing electrolyte to the positive electrode; and
a second flow plate to distribute the second flowing electrolyte to the negative electrolyte,
wherein a concentration of ions in the first group is greater than a concentration of ions in the second group.
